(19) United States
(12) Patent Application Publication
(10) Pub. No.: US 2020/0143415 A1
(43) Pub. Date: May 7, 2020

(54) SYSTEMS AND METHODS FOR FEED STREAM TRANSMISSION

(71) Applicant: BEIJING DIDI INFINITY TECHNOLOGY AND DEVELOPMENT CO., LTD, Beijing (CN)

(72) Inventor: Yan DAI, Beijing (CN)

(73) Assignee: BEIJING DIDI INFINITY TECHNOLOGY AND DEVELOPMENT CO., LTD., Beijing (CN)

(21) Appl. No.: 16/729,193

(22) Filed: Dec. 27, 2019

Related U.S. Application Data
(63) Continuation of application No. PCT/CN2018/092320, filed on Jun. 22, 2018.

(30) Foreign Application Priority Data
Jun. 29, 2017 (CN) 201710516124.9

(51) Int. Cl. G06Q 30/02; H04L 29/08; G06F 3/0484

(52) U.S. Cl. CPC G06Q 30/0244; H04L 67/22; G06Q 30/0202; G06F 3/04847; G06Q 30/0246; H04L 67/26

(57) ABSTRACT

A method for transmitting feed stream may include receiving, over a network, a request for transmitting feed stream to a user interface of an application installed in a terminal device, wherein the request is associated with one or more users of the terminal device and the user interface is to be displayed to the one or more users. The method may also include determining at least one operating control element to be displayed in the user interface, wherein the operating control element is selected from one or more pre-arranged control elements based on historical behavior data of the one or more users. The method may further include transmitting feed stream to the terminal device over the network, wherein the feed stream is configured to prompt the application to display the operating control element in the user interface of the application.

### CROSS-REFERENCE TO RELATED APPLICATIONS

This application is a continuation of International Application No. PCT/CN2018/092320, filed on Jun. 22, 2018, which claims priority to Chinese Patent Application No. 201710516124.9, filed on Jun. 29, 2017, the contents of which are incorporated herein by reference in their entirety.

### TECHNICAL FIELD

The present disclosure generally relates to communication technology, and in particular, to systems and methods for transmitting feed stream to user interfaces of terminal devices.

### BACKGROUND

Nowadays, online to offline services are often associated with mobile applications. For example, car-hailing applications are commonly installed on terminal devices, such as smartphones. A user may request a service through the car-hailing application on his/her smartphone, and communicate with a driver providing the service directly via the car-hailing application, thus improving travel efficiency.

At present, applications (e.g. a car-hailing application) may function with standardized information and process operations. In some cases, the same operating control elements may be displayed when different users request for the same service via the car-hailing applications installed on their terminal devices. Here, an operating control element refer to an operating control in a user interface through which a user may accomplish desired functions or services by clicking, marking or moving the operating control element and/or inputting information into the operating control element.

Taking an operation that a user pays a service fee through the car-hailing application as an example, a rating control element is routinely displayed on the terminal device of the user after the user pays the service fee, such that the user may rate the service provided by the driver. However, since different users have different preferences or habits, some users may prefer not to see the rating interface for the car-hailing service. Thus, in some occasions, standardized information and process operations may negatively impact the overall experience of the user. It is therefore desirable to provide systems and methods that control feed streams to the user terminals for varied display and improved experience.

### SUMMARY

In an aspect of the present disclosure, a system for transmitting feed stream may be provided. The system may include at least one storage medium storing a set of instructions, at least one communication platform connected to a network, and at least one processor configured to communicate with the at least one storage medium or the at least one communication platform, wherein when executing the set of instructions, the at least one processor is directed to cause the system to receive, over the network, a request for transmitting feed stream to a user interface of an application installed in a terminal device, wherein the request is associated with one or more users of the terminal device and the user interface is to be displayed to the one or more users; determine at least one operating control element to be displayed in the user interface, wherein the operating control element is selected from one or more pre-arranged control elements based on historical behavior data of the one or more users; and transmit feed stream to the terminal device over the network, wherein the feed stream is configured to prompt the application to display the operating control element in the user interface of the application.

In some embodiments, to determine the at least one operating control element to be displayed in the user interface, the at least one processor is directed to cause the system to process the historical behavior data to predict preferences of the one or more users and selecting the at least one operating control element according to the predicted user preferences.

In some embodiments, to determine the at least one operating control element to be displayed in the user interface, the at least one processor is directed to cause the system to determine a frequency that the one or more users view advertisements in the user interface based on the historical behavior data; determine whether the frequency is smaller than a preset frequency; and in response to the determination that the frequency is smaller than the preset frequency, select the at least one operating control element by excluding a control element corresponding to the advertisements.

In some embodiments, the one or more users include a service provider or a service requestor.

In some embodiments, the at least one operating control element associates the service requestor with the communication platform and the service provider.

In some embodiments, to determine the at least one operating control element to be displayed in the user interface, the at least one processor is directed to cause the system to determine the number of at least one first rate of a service provider based on the historical behavior data of the one or more users, wherein the first rate is larger than or equal to a preset rate; determine whether the number of the at least one first rate is larger than or equal to a preset number; and in response to the determination that the number of the at least one first rate is larger than or equal to the preset number, select the at least one operating control element by excluding a control element corresponding to the rating of the service provider.

In some embodiments, to determining the at least one operating control element to be displayed in the user interface, the at least one processor is directed to cause the system to: determine whether the user terminal is a preset type of user terminal; and in response to the determination that the user terminal is the preset type of user terminal, determine the one or more manipulation controls to be displayed in the user interface based on the preset type.

In some embodiments, the at least one processor is further directed to cause the system to obtain a location of the terminal device; determine a supply-demand ratio of a first transportation service associated with the user interface within a preset range of the location of the terminal device; determine whether the supply-demand ratio of the first transportation service is smaller than or equal to a preset supply-demand ratio; and in response to the supply-demand ratio of the first transportation service is smaller than or equal to a preset supply-demand ratio, determine prompting information to be displayed in the user interface, wherein the prompting information includes a second transportation service, a supply-demand ratio of the second transportation service within the preset range of the location of the terminal device, and a response time of the second transportation service.

In some embodiments, the first transportation service and the second transportation service are car-hailing services.

In some embodiments, the historical behavior data includes selections of transportation services of the one or more users.

In some embodiments, wherein to determine the prompting information to be displayed in the user interface, the at least one processor is directed to cause the system to determine a type of the first transportation service; determine a second transportation service based on the type of the first transportation service and the supply-demand ratio of the first transportation service, wherein the supply-demand ratio of the second transportation service is larger than the supply-demand ratio of the first transportation service; obtain information of the second transportation service, wherein the information of the second transportation service includes the response time of the second transportation service; and determine the prompting information to be displayed in the user interface based on the information of the second transportation service.

In another aspect of the present disclosure, a method may be provided. The method may be implemented on a computing device having at least one processor, at least one communication platform, and at least one computer-readable storage medium, the method comprising receiving, over a network, a request for transmitting feed stream to a user interface of an application installed in a terminal device, wherein the request is associated with one or more users of the terminal device and the user interface is to be displayed to the one or more users; determining at least one operating control element to be displayed in the user interface, wherein the operating control element is selected from one or more pre-arranged control elements based on historical behavior data of the one or more users; and transmitting feed stream to the terminal device over the network, wherein the feed stream is configured to prompt the application to display the operating control element in the user interface of the application.

In a further aspect of the present disclosure, a non-transitory medium storing instructions is provided. The non-transitory medium may comprise a set of instructions, wherein when executed by at least one processor, the set of instructions directs the at least one processor to effectuate a method, the method comprising receiving, over a network, a request for transmitting feed stream to a user interface of an application installed in a terminal device, wherein the request is associated with one or more users of the terminal device and the user interface is to be displayed to the one or more users; determining at least one operating control element to be displayed in the user interface, wherein the operating control element is selected from one or more pre-arranged control elements based on historical behavior data of the one or more users; and transmitting feed stream to the terminal device over the network, wherein the feed stream is configured to prompt the application to display the operating control element in the user interface of the application.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A is a schematic diagram illustrating an exemplary feed stream transmitting system according to some embodiments of the present disclosure;

FIG. 1B is a schematic diagram illustrating another exemplary feed stream transmitting system according to some embodiments of the present disclosure;

FIG. 2 is a schematic diagram illustrating exemplary components of a computing apparatus according to some embodiments of the present disclosure;

FIG. 3 is a block diagram illustrating exemplary hardware and/or software components of an exemplary mobile device according to some embodiments of the present disclosure;

FIG. 4 is a block diagram illustrating an exemplary processing engine according to some embodiments of the present disclosure;

FIG. 5 is a flow chart illustrating an exemplary process for transmitting feed stream to a terminal device according to some embodiments of the present disclosure;

FIG. 6 is a flow chart illustrating a process for determining the at least one operating control element to be displayed in the user interface according to some embodiments of the present disclosure;

FIG. 7 is a flow chart illustrating a process for determining at least one manipulation control element to be displayed in the user interface according to some embodiments of the present disclosure; and

FIG. 8 is a flow chart illustrating a process for determining prompting information to be displayed in the user interface according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding assigning service requests for transportation services, it should also be understood that this is only one exemplary embodiment. The systems or methods of the present disclosure may be applied to any other kind of online to offline services. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a terminal device terminal, a custom system, an internal analysis system, an artificial intelligence robot, or the like, or any combination thereof.

The terms “passenger,” “requester,” “requestor,” “service requester,” “service requestor,” and “customer” in the present disclosure are used interchangeably to refer to an individual, an entity or a tool that may request or order a service. Also, the terms “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. In the present disclosure, terms “requester” and “requester terminal” may be used interchangeably, and terms “provider” and “provider terminal” may be used interchangeably.

The terms “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

It should be noted that an online to offline service, such as online taxi-hailing including taxi hailing combination services, is a new form of service rooted only in post-Internet era. It provides technical solutions to users and service providers that could raise only in post-Internet era. In pre-Internet era, when a passenger hails a taxi on the street, the taxi request and acceptance occur only between the passenger and one taxi driver that sees the passenger. If the passenger hails a taxi through a telephone call, the service request and acceptance may occur only between the passenger and one service provider (e.g., one taxi company or agent). Online taxi, however, allows a user of the service to real-time and automatically distribute a service request to a vast number of individual service providers (e.g., taxi) distance away from the user. It also allows a plurality of service providers to respond to the service request simultaneously and in real-time. Therefore, through the Internet, the online on-demand transportation systems may provide a much more efficient transaction platform for the users and the service providers that may never meet in a traditional pre-Internet transportation service system.

In an aspect, the present disclosure is directed to a system and method for feed stream transmission. The system may select at least one operating control element from pre-arranged operating control element to be displayed in a user interface based on behavior data of one or more users regarding the user interface. The system may transmit feed stream including the selected operating control elements to a terminal device for display.

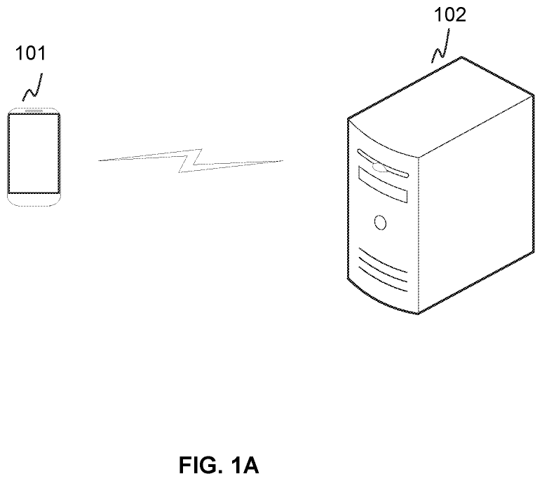

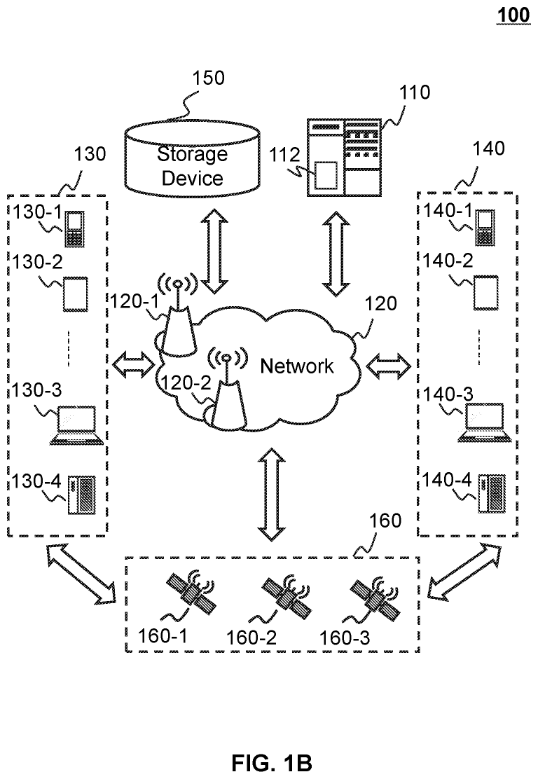

FIG. 1A is a schematic diagram illustrating an exemplary feed stream transmitting system according to some embodiments of the present disclosure. Merely by ways of example, the feed stream transmitting system 100 may facilitate feed stream transmission in a car-hailing service. As shown in FIG. 1A, the feed stream transmitting system 100 may include a terminal device 101 and a server 102. The terminal device 101 may be, for example, a mobile device, on which a car-hailing application is installed. The terminal device 101 may require data related to the car-hailing application from the server 102 over a network (e.g. the Internet). The server 102 may transmit feed stream including the required data to the car-hailing application on the terminal device 101 over the Internet.

In some embodiments, the terminal device 101 may send a request for feed stream associated with an interface of the car-hailing application to the server 102 when a user of the terminal device 101 opens the car-hailing application. The terminal device 101 may receive the feed stream including data for generating operating control elements to be displayed in the user interface from the server 102. Thus, the terminal device 101 may generate the operating control elements based on the obtained data, and display the operating control elements in the user interface of the car-hailing application. As used herein, the operating control elements refer to operating controls in a user interface of the car-hailing application through which various types of functions or services related to the car-hailing application may be realized. For example, a user may pay his/her bill through a payment control element. In some embodiments, a user may accomplish desired functions or services by clicking or moving an operating control element and/or inputting information through an operating control element. To some extent, the operating control elements may associate the service requestor (also referred to as a “user” in the car-hailing service) with the service provider (also referred to as a “driver” in the car-hailing service) and the communication platform or the server of the communication platform. Exemplary operating control elements may include payment control elements, advertising control elements, rating control elements, service requesting control elements, or the like. In some embodiments, a user interface of the car-hailing application may include more than one operating control element. For example, a payment interface may include a payment control element for paying service fee and a rating control element for rating the service of a service provider.

In some embodiments, the car-hailing application may function with standardized information and process operations. In this case, same operating control elements may be displayed when different users request for a same service via car-hailing applications installed on their terminal devices.

Taking a payment interface of an application related to a service as an example, whenever a terminal device sends a request for acquiring feed stream related to the payment interface to the server 102, the server 102 may transmit the feed stream including data for generating a payment control element and a rating control element to the terminal device. The terminal device may generate a payment control element and a rating control element to be displayed in the payment interface based on the received data. In this way, the user may pay his/her bill via the payment control element, and rate the service via the rating control element. However, since users of the car-hailing application may have different habits or preferences (e.g., some users may not prefer to rate the service via the rating control element), a car-hailing application functioning with standardized information and process operations may have negative effects on user experiences.

In some embodiments, feed stream associated with an interface of a car-hailing application may be generated based on behavior data of one or more users, such that terminal devices of different users may display interfaces including personalized operating control elements. Therefore, the system and method of transmitting feed stream related to a car-hailing application disclosed in the present invention is intended to solve realistic problems that have been existing in car-hailing services.

In some embodiments, the server 102 may be a part of a communication platform (not shown in the figure). The communication platform may be configured to provide online services, such as an online to offline service (e.g., a taxi service, a carpooling service, a food delivery service, a party organization service, an express service, etc.), an unmanned driving service a map-based service (e.g., a route planning service), etc. The communication platform may generate feed stream, for example, based on the data and/or information received from a terminal device of a user, and transmit the generated feed stream to the terminal device.

Technical solutions below will be described in detail by means of specific embodiments. The following specific embodiments may be combined with each other, and same or similar concepts or procedures may not be repeated in some embodiments.

FIG. 1B is a schematic diagram illustrating another exemplary feed stream transmitting system according to some embodiments of the present disclosure. For example, the feed stream transmitting system 100 may facilitate feed stream transmission between service providers and service requestors in various types of services such as shopping services, car-hailing services, chauffeur services, delivery services, carpooling services, bus services, take-out services, driver hiring services, etc. For brevity, the methods and/or systems described in the present disclosure may take a form of a car-hailing service. It should be noted that the car-hailing service is merely provided for the purposes of illustration, and not intended to limit the scope of the present disclosure. For persons having ordinary skills in the art, the methods and/or systems described in the present disclosure may be applied to other similar situations, such as a take-out service, a delivery service, etc.

The feed stream transmitting system 100 may include a server 110, a network 120, a requester terminal 130, a provider terminal 140, a storage device 150, and a positioning device 160. The server 110 may include a processing engine 112.

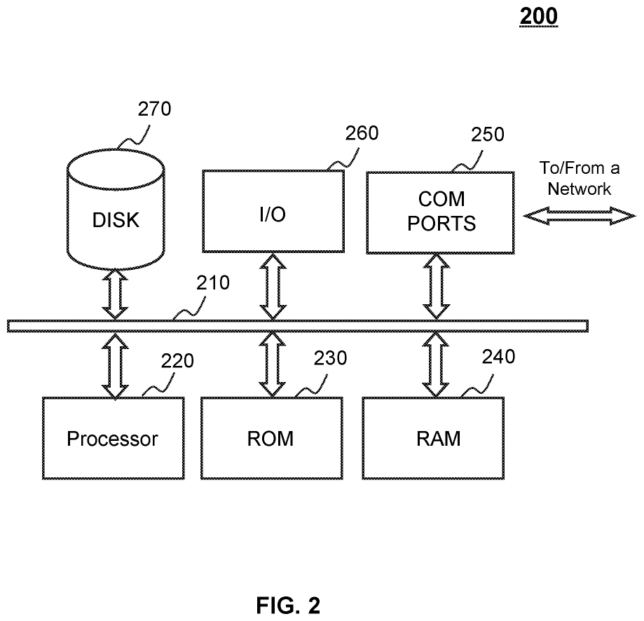

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, and/or the storage device 150 via the network 120. As another example, the server 110 may be directly connected to the requester terminal 130, the provider terminal 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing apparatus 200 having one or more components illustrated in FIG. 2 in the present disclosure.

In some embodiments, the server 110 may include a processing engine 112. The processing engine 112 may process information and/or data relating to the feed stream transmission. For example, the processing engine 112 may determine at least one operating control element to be displayed in a user interface by processing behavior data of one or more users associated with the user interface. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the feed stream transmitting system 100 (e.g., the server 110, the requester terminal 130, the provider terminal 140, the storage device 150, and the positioning device 160) may send information and/or data to other component(s) in the feed stream transmitting system 100 via the network 120. For example, the server 110 may obtain/acquire a request for transmitting feed stream to a user interface from the requester terminal 130 via the network 120. In some embodiments, the network 120 may be any type of wired or wireless network, or a combination thereof. Merely by way of example, the network 130 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the feed stream transmitting system 100 may be connected to the network 120 to exchange data and/or information.

In some embodiments, a requester may be a user of the requester terminal 130. In some embodiments, a provider may be a user of the provider terminal 140. In some embodiments, “requester” and “requester terminal” may be used interchangeably, and “provider” and “provider terminal” may be used interchangeably.

In some embodiments, the requester terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile device may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, a built-in device in the motor vehicle 130-4 may include an onboard computer, an onboard television, etc. In some embodiments, the requester terminal 130 may be a device with positioning technology for locating the position of a user of the requester terminal 130 (e.g., a service requester) and/or the requester terminal 130.

In some embodiments, the provider terminal 140 may be a device that is similar to, or the same as the requester terminal 130. In some embodiments, the provider terminal 140 may be a device utilizing positioning technology for locating the position of a user of the provider terminal 140 (e.g., a service provider) and/or the provider terminal 140. In some embodiments, the requester terminal 130 and/or the provider terminal 140 may communicate with one or more other positioning devices to determine the position of the requester, the requester terminal 130, the provider, and/or the provider terminal 140. In some embodiments, the requester terminal 130 and/or the provider terminal 140 may send positioning information to the server 110.

The storage device 150 may store data and/or instructions. In some embodiments, the storage device 150 may store data obtained from the requester terminal 130 and/or the provider terminal 140. In some embodiments, the storage device 150 may store data and/or instructions that the server 110 may execute or use to perform exemplary methods described in the present disclosure. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the feed stream transmitting system 100 (e.g., the server 110, the requester terminal 130, the provider terminal 140, etc.). One or more components in the feed stream transmitting system 100 may access the data or instructions stored in the storage device 150 via the network 120. In some embodiments, the storage device 150 may be directly connected to or communicate with one or more components in the feed stream transmitting system 100 (e.g., the server 110, the requester terminal 130, the provider terminal 140, etc.). In some embodiments, one or more components in the feed stream transmitting system 100 (e.g., the server 110, the requester terminal 130, the provider terminal 140, etc.) may have permission to access the storage device 150. In some embodiments, the storage device 150 may be part of the server 110.

The positioning device 160 may determine information associated with an object, for example, the requester terminal 130, the provider terminal 140, etc. For example, the positioning device 160 may determine a location of the requester terminal 130. In some embodiments, the positioning device 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The location may be in the form of coordinates, such as, latitude coordinate and longitude coordinate, etc. The positioning device 160 may communicate with one or more satellites, for example, a satellite 160-1, a satellite 160-2, and a satellite 160-3. The satellites 160-1 through 160-3 may determine the information mentioned above independently or jointly. The satellite positioning device 160 may send the information mentioned above to the network 120, the requester terminal 130, or the provider terminal 140 via wireless connections.

In some embodiments, information exchanging of one or more components in the feed stream transmitting system 100 may be initiated by way of service requests. The object of the service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary components of a computing apparatus according to some embodiments of the present disclosure. The server 110, the requestor terminal 130, the provider terminal 140, and/or the storage device 150 may be implemented on the computing apparatus 200 according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing apparatus 200 may be configured to implement any components that perform one or more functions disclosed in the present disclosure. For example, the computing apparatus 200 may implement any component of the feed stream transmitting system 100 as described herein. In FIGS. 1-2, only one such computing apparatus is shown purely for convenience purposes. One of ordinary skill in the art would understood at the time of filing of this application that the computer functions relating to the service as described herein may be implemented in a distributed fashion on a number of similar platforms, to distribute the processing load.

The computing apparatus 200, for example, may include COM ports 250 connected to and from a network connected thereto to facilitate data communications. The computing apparatus 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing apparatus may include the internal communication bus 210, program storage and data storage of different forms including, for example, a disk 270, and a read only memory (ROM) 230, or a random access memory (RAM) 240, for various data files to be processed and/or transmitted by the computing apparatus. The exemplary computing apparatus may also include program instructions stored in the ROM 230, RAM 240, and/or other type of non-transitory storage medium to be executed by the processor 220. The methods and/or processes of the present disclosure may be implemented as the program instructions. The computing apparatus 200 also includes an I/O component 260, supporting input/output between the computer and other components. The computing apparatus 200 may also receive programming and data via network communications.

Merely for illustration, only one processor and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing apparatus 200 executes both step A and step B, it should be understood that step A and step B may also be performed by two different CPUs and/or processors jointly or separately in the computing apparatus 200 (e.g., the first processor executes step A and the second processor executes step B, or the first and second processors jointly execute steps A and B).

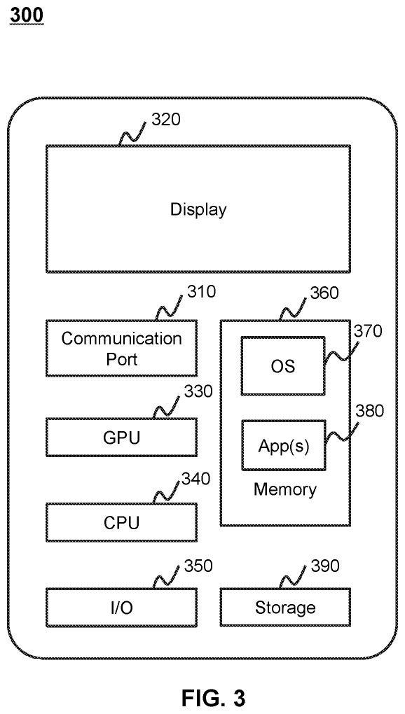

FIG. 3 is a block diagram illustrating exemplary hardware and/or software components of an exemplary mobile device according to some embodiments of the present disclosure. The requestor terminal 130 may be implemented on the mobile device 300 according to some embodiments of the present disclosure. As illustrated in FIG. 3, the mobile device 300 may include a communication module 310, a display 320, a graphics processing unit (GPU) 330, a central processing unit (CPU) 340, an I/O 350, a memory 360, and a storage 390. The CPU 340 may include interface circuits and processing circuits similar to the processor 210. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for transmitting the trajectory data to the server 110. User interaction with the information stream may be achieved via the I/O devices 350 and provided to the processing engine 112 and/or other components of the system 100 via the network 120.

In order to implement various modules, units and their functions described above, a computer hardware platform may be used as hardware platforms of one or more elements (e.g., a component of the server 110 described in FIG. 1). Since these hardware elements, operating systems, and program languages are common, it may be assumed that persons skilled in the art may be familiar with these techniques and they may be able to provide information required in the traffic lights controlling according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

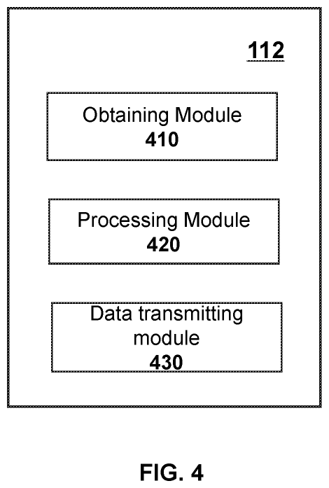

FIG. 4 is a block diagram illustrating an exemplary processing engine according to some embodiments of the present disclosure. As shown in FIG. 4, the processing engine for transmitting feed stream of one or more operating control elements of a car-hailing application may be implemented as a part of the server through software, hardware, or a combination of both. The processing engine 112 may include an obtaining module 410, a processing module 420, and a data transmitting module 430.

The obtaining module 410 may receive a request sent by a terminal device on which a car-hailing application is installed. In some embodiments, the request may be used to direct the server 102 to transmit the feed stream to the user interface of the car-hailing application.

The processing module 420 may determine at least one operating control element to be displayed in the user interface. In some embodiments, the operating control element may be selected from one or more pre-arranged control elements based on historical behavior data of the one or more users. The pre-arranged control elements may include payment control elements, advertising control elements, rating control elements, service requesting control elements, or the like. In some embodiments, the processing module 420 may determine the at least one operating control element to be displayed in the user interface after the server 102 receives the request sent by the terminal device.

The data transmitting module 430 may transmit feed stream including data for generating the at least one operating control element to the terminal device.

In some embodiments, the processing module 420 may determine the value of at least one first rate of a service provider based on the historical behavior data of the one or more users when the user opens a payment interface. If the value of the first rate is greater than the preset number, it may indicate that services provided by the service provider are satisfying (i.e., the probability that the service provider providing an unsatisfying service may be negligible). In such a case, the server 102 may select at least one operating control element by excluding an operating control element corresponding to the rating of the service provider (e.g., a rating control element) to reduce unnecessary operating control elements.

In some embodiments, the terminal devices that are used to pay service fees may be divided into a first type and a second type. Terminal devices of a first type may correspond to users who are used to rate the services when they pay the service fees, and terminal devices of a second type may correspond to users who seldom rate the services when they pay the service fees.

In some embodiments, if the processing module 420 determines that the terminal device sending the request is a terminal device of the first type and the first rate is greater than the preset rate, the processing module 420 may select at least one operating control element by excluding the rating control element to be displayed in the payment interface. If the processing module 420 determines that the terminal device sending the request is a terminal device of the second type and the first rate is greater than the preset rate, the processing module 420 may select at least one operating control element including the rating control element to be displayed in the payment interface.

In some embodiments, the processing module 420 may determine a frequency that a user views advertisements in the user interface based on behavior data of the user regarding the user interface. If the frequency that the user views the advertisements is smaller than the preset threshold, the processing module 420 may transmit feed streams including data for generating operating control elements corresponding to a portion of the advertisements and other operating control elements (e.g., payment control elements).

In some embodiments, the at least one operating control element may include a control element that the user may operate in the user interface for a number of times more than a preset threshold.

In some embodiments, the processing module 420 may determine a supply-demand ratio of a first transportation service associated with the user interface within a preset distance range of the location of the terminal device. The processing module 420 may determine prompting information to be displayed in the service requesting interface when the supply-demand ratio of the first transportation service is smaller than or equal to a preset threshold (e.g., a preset supply-demand ratio).

In some embodiments, the first transportation service may correspond to the user interface of the terminal device. In some embodiments, the prompting information may be associated with a second transportation service. The second transportation service may include, for example, a carpooling service, a taxi-hailing service, a chauffeur service, a delivery service, a bus service, etc. In some embodiments, the supply-demand ratio of the second transportation service is greater than the supply-demand ratio of the first transportation service. In some embodiments, the second transportation service may differ from the first transportation service.

Merely by ways of example, the prompting information include response information of the second transportation service. In some embodiments, the response information of the second transportation service may further include a response time of the second transportation service, and a name of the second transportation service.

In some embodiments, the data transmitting module 430 may transmit feed stream including data for generating the at least one operating control element to the terminal device.

In some embodiments, the processing module 420 may determine the type of transportation service that the user accepts based on behavior data of the user. In some embodiments, the processing module 420 may designate a transportation service that conforms to the type of transportation service that the user accepts and has a higher supply-demand ratio than that of the first transportation service in the preset distance range in which the terminal device is located as the second transportation service. The processing module 420 may generate the prompting information including response information of the second transportation service. In some embodiments, the server may designate a transportation service with a highest supply-demand ratio as the second transportation service.

The modules in FIG. 4 may be connected to or communicate with each other via a wired connection or a wireless connection. The wired connection may include a metal cable, an optical cable, a hybrid cable, or the like, or a combination thereof. The wireless connection may include a Local Area Network (LAN), a Wide Area Network (WAN), a Bluetooth, a ZigBee, a Near Field Communication (NFC), or the like, or a combination thereof. Two or more of the modules may be combined into a single module, and any one of the modules may be divided into two or more units.

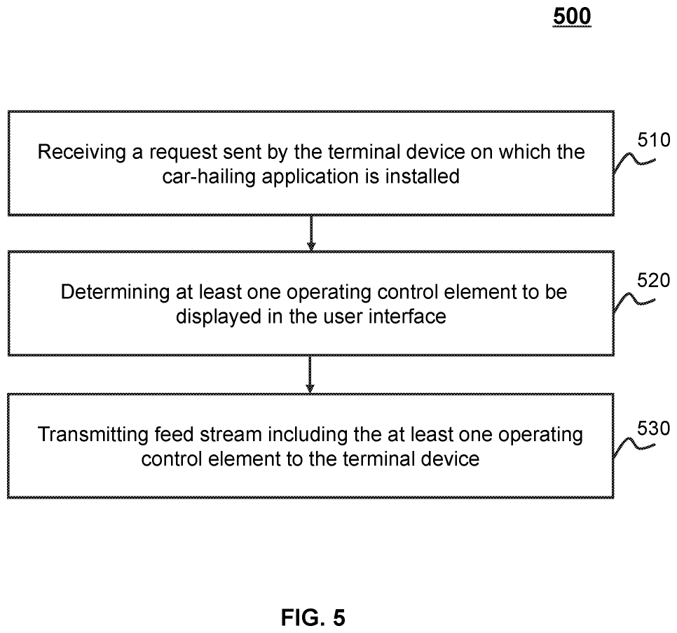

FIG. 5 is a flow chart illustrating an exemplary process for transmitting feed stream to a terminal device according to some embodiments of the present disclosure. The executive subject of the process 500 may be a device for transmitting feed stream associated with a car-hailing application, a server 102 including the device for transmitting the feed stream, or the processing engine 112 of the server 102. Merely for illustration purposes, the embodiment below (e.g., the processes 500 through 800) is described in combination with the server 102 including the device for transmitting feed stream associated with a car-hailing application. The present embodiment relates to a specific process in which the server 102 may transmit feed stream associated with a user interface of a car-hailing application to a terminal device of a user based on obtained user behavior data regarding the user interface after the server 102 receives a request for transmitting the feed stream to the car-hailing application installed on the terminal device.

In 510, the server 102 may receive a request sent by the terminal device on which the car-hailing application is installed. The request may be used to direct the server 102 to transmit feed stream to a user interface of the car-hailing application over a network.

In some embodiments, after a user of the terminal device opens the interface of the car-hailing application, the terminal device may send the request to the server so as to direct the server 102 to transmit the feed stream to the user interface of the car-hailing application.

In 520, the server 102 may determine at least one operating control element to be displayed in the user interface. In some embodiments, the operating control element may be selected from one or more pre-arranged control elements based on historical behavior data of the one or more users. The pre-arranged control elements may include payment control elements, advertising control elements, rating control elements, service requesting control elements, or the like. In some embodiments, a user interface of the car-hailing application may include one or more operating control elements. For example, a payment interface may include a payment control element for paying service fee and a rating control element for rating a service of a service provider.

In some embodiments, the server 102 may determine the at least one operating control element to be displayed in the user interface after the server 102 receives the request sent by the terminal device, such that the at least one operating control element to be displayed may satisfy the user's requirements and may not influence normal use of the car-hailing application. In this way, the purpose of displaying different operating control elements on different terminal devices may be achieved.

In some embodiments, the behavior data used herein may refer to historical behavior data of the user of the terminal device. In some embodiments, the user behavior data may include behavior data of other users associated with the user interface of the car-hailing application. For example, when a user requests a service via a user interface of a car-hailing application installed on his/her mobile phone, the server 102 may obtain behavior data of the user and a driver who responds to the service request.

Merely by ways of example, the behavior data may include selection of transportation services, rating of transportation services of different types, historical travel time periods, interactions (e.g., clicks or input) with one or more operating control elements in the user interface of the car-hailing application, or the like, or a combination thereof. In some embodiments, behavior data of a user may reflect conscious status of a user. For example, behavior data that a user rates a car-hailing service by inputting a number (e.g., 4.5) into a rating control element of the car-hailing application may reflect a degree of satisfaction for a car-hailing service. In some embodiments, the behavior data may also reflect unconscious status (e.g., preferences or habits) of the user. For example, behavior data that a user selects a certain transportation service (e.g., an express service, a carpooling service, a premier service, etc.) may reflect certain unconscious status of the user. In some embodiments, the preferences or habits of the users may be determined by analyzing historical behavior data of the user.

In some embodiments, the behavior data may relate to the user interface. For example, when the user pays a bill through a payment interface, the server 102 may select operating control elements from one or more pre-arranged control elements based on behavior data such as historical orders of the user. Detailed description of the process for determining the at least one operating control element to be displayed in the user interface may be disclosed below.

In 530, the server 102 may transmit feed stream including the at least one operating control element to the terminal device.

In some embodiments, the server 102 may transmit the feed stream including the at least one operating control element to the terminal device after the server 102 determines the at least one operating control element to be displayed in the user interface based on the obtained behavior data of one or more users associated with the user interface, such that the terminal device may generate the at least one operating control element, and display the at least one operating control element in the user interface based on the data in the feed stream. In some embodiments, the feed stream may be configured to prompt the application to display the determined operating control element in the user interface of the application.

In some embodiments, the feed stream may include an identifier for the determined operating control element. After the terminal device receives the feed stream (thus receiving the identifier), the terminal device may identify the determined operating control element, and display the operating control element in the interface.

Further, on the basis of the embodiment described above, the following embodiment relates to a process in which the server 102 determines the at least one operating control element to be displayed in the user interface by processing obtained behavior data regarding the user interface.

In some embodiments, the server 102 may obtain behavior data regarding the user interface in a preset time duration (e.g., last week, last month, etc.). In some embodiments, the behavior data may be obtained from a storage device (e.g., the storage device 150) or terminal devices of one or more users. The server 102 may determine, based on the behavior data regarding the user interface, one or more operating control elements that the user may operate in the user interface. In some embodiments, the server 102 may select the operating control elements that the user of the terminal device uses frequently (e.g., with a frequency of use greater than a preset threshold) from one or more pre-arranged control elements. The server 102 may determine the selected operating control elements as the at least one operating control element to be displayed in the user interface. In some embodiments, the preset threshold may be determined according to the preset time duration.

Merely by ways of example, a user A may send a request for feed stream of a payment interface of the car-hailing application to the server 102 via his/her terminal device. The server 102 may determine one or more operating control elements that the user A may use in the user interface frequently (e.g., with a frequency of use greater than a preset threshold) by analyzing the behavior data of the user A regarding the payment interface within a preset time duration (e.g., last two weeks).

If it is determined that the user A is not interested in a rating control element or an advertising control element, the server 102 may select, from pre-arranged operating control elements, one or more operating control elements necessary to pay service fee by excluding other operating control elements such as the rating control element and the advertising control element, and transmit feed stream including the selected one or more operating control elements into the user interface for display.

In some embodiments, the server 102 may determine the interests or preferences of the user A based on the behavior data of user A regarding the payment interface within the preset time duration. For example, if user A neither uses the rating control element nor clicks the advertisements in the user interface of the car-hailing application, the server 102 may determine that the user A may not need other contents in the payment interface except the payment control element.

Thus, the server 102 may transmit feed stream including the operating control elements necessary to pay the service fee to the terminal device of the user A, such that the user A may interact with the operating control elements that he/she uses frequently in the interface of the car-hailing application, thereby improving user experience of the user A.

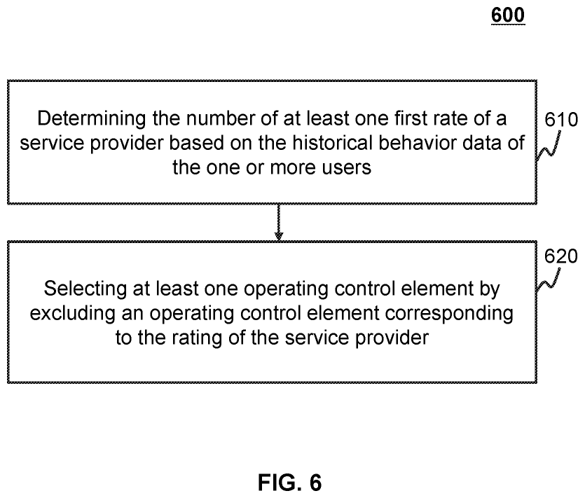

FIG. 6 is a flow chart illustrating a process for determining the at least one operating control element to be displayed in the user interface according to some embodiments of the present disclosure. In some embodiments, the process 600 may be implemented in the feed stream transmitting system 100. For example, the process 600 may be stored in the storage device 150 and/or the storage (e.g., the ROM 230) as a form of instructions, and invoked and/or executed by the server 110 (e.g., the processing engine 112 in the server 110, or the processor of the processing engine 112 in the server 110).

In 610, the server 102 may determine the value of at least one first rate of a service provider based on the historical behavior data of the one or more users. In some embodiments, the at least one first rate may be higher than or equal to a preset threshold (e.g., a preset rate). The first rate may be a certain value, for example, 3.5, 4, 5, etc. A higher rate may indicate that the service provider (also referred to as a “driver” in a car-hailing service) provides a service with a higher quality. In some embodiments, each user may rate the service provided by the driver, which may be recorded as historical behavior data regarding the driver.

In some embodiments, the terminal device may send a request for obtaining feed stream of a payment interface to the server after the user arrives his/her destination, and wants to pay the car-hailing service fee to a driver providing the car-hailing service.

In some embodiments, the server 102 may obtain rates of the driver within a preset time period based on historical behavior data regarding the driver after the server 102 receives the request from the user. The historical behavior data regarding the driver may include rates of services provided by the driver within the preset time period (e.g., last two month, last week, etc.). In some embodiments, the rates of services provided by the driver may be obtained from terminal devices of different users. In some embodiments, the server 102 may obtain the value of the at least one first rate greater than or equal to the first preset rate based on the rates of services provided by the driver.

The server 102 may evaluate the quality of services provided by the driver r based on first preset rate. The first preset rate may be set by a user (e.g., a technician), according to default settings of the feed stream transmitting system 100. In some embodiments, the first preset rate may be set based on requirements of a user. If a rate from a user is greater than or equal to the preset rate, it may indicate that the service provided for the user is satisfying. If a rate from a user is smaller than the preset rate, it may indicate that the service provided for the user is unsatisfying.

In 620, the server 102 may select at least one operating control element by excluding an operating control element corresponding to the rating of the service provider.

In some embodiments, the server 102 may calculate the value of each of the at least one first rate within the preset time period after the server obtains the at least one first rate. The server may compare the value of each of the at least one first rate with a preset value. If the value of a first rate is greater than the preset value, it may indicate that services provided by the service provider are satisfying (i.e., the probability that the service provider providing an unsatisfying service may be negligible). In such a case, the server 102 may select at least one operating control element by excluding an operating control element corresponding to the rating of the service provider (e.g., a rating control element) to reduce unnecessary operating control elements.

Merely by ways of example, services provided by a driver may be determined to be satisfying if the value of the at least one first rate (e.g., 4.9 or 5.0) within a preset time duration (e.g., last three months) is greater than a preset value (e.g., 3000). In this case, the server 102 may select at least one operating control element by excluding the rating control element to be displayed in the payment interface of the car-hailing application, and transmit feed stream including the selected operating control element to the terminal device of the service requestor. In this way, the terminal device may display the payment control element in the payment interface. The user may pay the service fee in the payment interface without rating the service provided by the service provider, thereby reducing unnecessary operations of the user.

In some embodiments, the server 102 may also categorize a terminal device of a service requestor into a first type and a second type by determining whether the service requestor has a habit or preference to rate the service provided by a service provider. Terminal devices of a first type may correspond to users who are used to rate the services when they pay the service fees, and terminal devices of a second type may correspond to users who seldom rate the services when they pay the service fees.

In some embodiments, the server 102 may determine whether a terminal device sending request for feed stream to the server 102 is a terminal device of the first type if the value of the at least one first rate is greater than the preset value. If the server 102 determines that the terminal device sending the request is a terminal device of the first type, the server 102 may select at least one operating control element by excluding the rating control element to be displayed in the payment interface. In another word, the terminal device may display the payment control element in the payment interface rather than the rating control element, such that the user may simply pay the service fee in the payment interface without rating the service provided by the service provider, thereby reducing unnecessary operations of the user.

Correspondingly, If the server 102 determines that the terminal device sending the request is a terminal device of the second type, the server 102 may select at least one operating control element including the rating control element to be displayed in the payment interface. In this way, the terminal device may display the payment control element in the payment interface as well as the rating control element, such that the user may rate the service provided by the service provider the service fee in the payment interface after he/she pays the service fee.

In some embodiments, the way in which the server 102 categorizes the terminal device into the first type and the second type is not limited. Merely for illustration purposes, if the preset value is M, the server 102 may categorize the first M terminal devices through which users pay service fees within a time period into the first type, and categorize the remaining terminal devices within the time period into the second type. In some embodiments, the server 102 may select M terminal devices through which users pay service fees within a time period randomly, and categorize the selected M terminal devices into the first type, and categorize the remaining terminal devices within the time period into the second type. In some embodiments, M may be a positive integer greater than or equal to 1.

In some embodiments, the feed stream associated with an interface of a car-hailing application may be flexible, such that terminal devices of different users may display interfaces including personalized operating control elements. Therefore, the system and method of transmitting feed stream related to a car-hailing application disclosed in the present invention may satisfy requirements from users, and may not bring about unnecessary troubles and extra burden to the users, thus improving overall experience of the users.

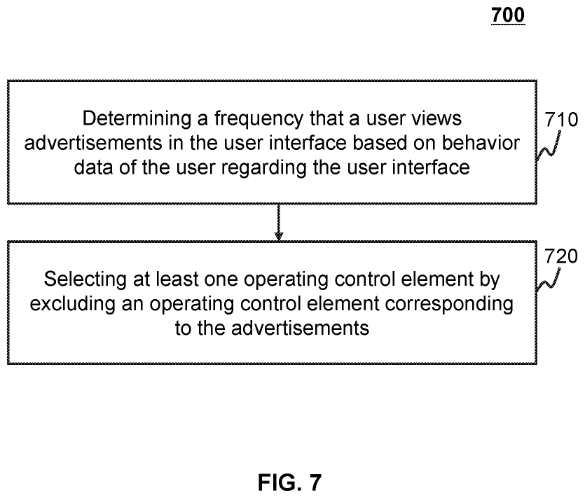

FIG. 7 is a flow chart illustrating a process for determining at least one manipulation control element to be displayed in the user interface according to some embodiments of the present disclosure. In some embodiments, the process 700 may be implemented in the feed stream transmitting system 100. For example, the process 700 may be stored in the storage device 150 and/or the storage (e.g., the ROM 230) as a form of instructions, and invoked and/or executed by the server 110 (e.g., the processing engine 112 in the server 110, or the processor of the processing engine 112 in the server 110).

In 710, the server 110 may determine a frequency that a user views advertisements in the user interface based on behavior data of the user regarding the user interface.

In some embodiments, the advertisements displayed in the user interface may be implemented in one or more advertising control elements. In some embodiments, the terminal device of the user may send a request for feed stream of the user interface to the server 102 when the user opens an interface of the car-hailing application including advertisements. In some embodiments, the frequency that the user views the advertisements may be determined by calculating a click rate of the advertisements in the user interface based on behavior data of the user. In some embodiments, the frequency that the user views the advertisements may be determined by calculating a frequency that the user does not close the advertisements when the advertisements are displayed in the user interface.

The server 102 may determine the frequency that the user views the advertisements in the user interface based on historical behavior data of user within a preset time duration. The frequency that the user views the advertisements may reflect whether the user is interested in the advertisements. The preset time duration may be a week, a month, half a year, etc.

In 720, the server 102 may select at least one operating control element by excluding an operating control element corresponding to the advertisements.

In some embodiments, the server 102 may determine whether the frequency that the user views the advertisements is smaller than a preset threshold (e.g., a preset frequency such as 3 times a week) after the server 102 determines the frequency that the user views the advertisements. If the frequency is smaller than the preset threshold, it may indicate that the user may not be interested in the advertisements. In such a case, transmitting feed stream including operating control elements corresponding to the advertisements (e.g., advertising control elements) may decrease the overall experience of the user. Thus, the server 102 may select at least one operating control element by excluding the advertising control elements.

Merely by ways of example, if the user does not click the advertisements in a user interface of the car-hailing application during last three months, the server 102 may determine the frequency that the user views the advertisements as 0. Since the frequency is smaller than a preset threshold (e.g., 10 times a month), the server 102 may select at least one operating control element by excluding advertising control elements, and transmit feed stream including the selected operating control element to the terminal device of the user, such that the advertisements may be displayed in the interface of the terminal device of the user.

In some embodiments, if the frequency that the user views the advertisements is smaller than the preset threshold, the server 102 may transmit feed streams including operating control elements corresponding to a portion of the advertisements and other operating control elements (e.g., payment control elements), such that the terminal device may display the portion of the advertisements in the user interface. In some embodiments, if the frequency that the user views the advertisements is smaller than the preset threshold, the server 102 may transmit feed streams including operating control elements other than operating control elements corresponding to the advertisements at pre-arranged time periods (e.g., 8 o'clock to 10 o'clock and 17 o'clock to 20 o'clock), and transmit feed streams including operating control elements corresponding to the advertisements at time periods other than the pre-arranged time periods (e.g., 13 o'clock to 15 o'clock, 21 o'clock to 23 o'clock, etc.).

The server may transmit feed streams including different operating control elements to terminal devices of different users in response to requests of the users regarding a same interface of the car-hailing application, such that terminal devices of different users may display interfaces including personalized operating control elements. In this case, requirements of the users may be satisfied without bringing about unnecessary troubles and extra burden, thus improving overall experience of the users.

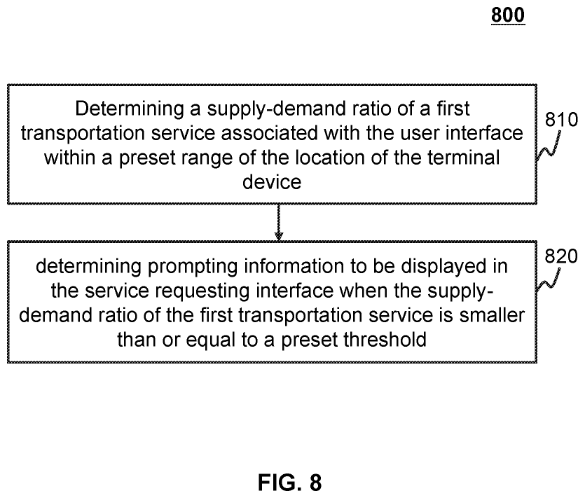

FIG. 8 is a flow chart illustrating a process for determining prompting information to be displayed in the user interface according to some embodiments of the present disclosure. In some embodiments, the process 800 may be implemented in the feed stream transmitting system 100. For example, the process 800 may be stored in the storage device 150 and/or the storage (e.g., the ROM 230) as a form of instructions, and invoked and/or executed by the server 110 (e.g., the processing engine 112 in the server 110, or the processor of the processing engine 112 in the server 110).

In 810, the server 102 may determine a supply-demand ratio of a first transportation service associated with the user interface within a preset range of the location of the terminal device.

In some embodiments, when a user opens a user interface to request a first transportation service (e.g., a carpooling service, a taxi-hailing service, a chauffeur service, a delivery service, a bus service, etc.) via the car-hailing application, the terminal device of the user may send a request for obtaining feed stream for the user interface to the server 102. In some embodiments, the request of the user may include location information. In some embodiments, the location information may include a current location of the terminal device (e.g., in a form of coordinates including latitude coordinate and longitude coordinate). In some embodiments, the location information may be obtained from the positioning device 160.

The server 110 may determine the supply-demand ratio of the first transportation service in a preset range based on the location information after the server 110 receives the request. The preset range may refer to an area such as a circular area, a square area, a hexagonal area, etc., in which the terminal device is located. The area may have a certain size. Merely by ways of example, the area may be a circular area with a radius of 1 kilometer, 3 kilometers, 5 kilometers, etc. The size of the area may be determined by a user, according to default settings of the server 102, etc.

In some embodiments, the server may determine the preset range (e.g. distance range) in which the terminal device is located based on the location of the terminal device and the shape and size of the area. Then the server 102 may count the number of vehicles of a first type providing the first transportation service in the preset range and the number of terminal devices requesting the first transportation service in the preset range. The server 102 may determine the supply-demand ratio of the first transportation service by calculating a ratio of the number of vehicles of a first type providing the first transportation service in the preset range to the number of terminal devices requesting the first transportation service in the preset range.

In some embodiments, the terminal device may send the location information to the server by means of a message. In some embodiments, the terminal device may send the location information to the server 102 using other suitable approaches, for example, local area network (LAN), a wireless local area network (WLAN), a public telephone switched network (PSTN), a Bluetooth™ network, a ZigBee network, a near field communication (NFC), etc.

In 820, the server 102 may determine prompting information to be displayed in the service requesting interface when the supply-demand ratio of the first transportation service is smaller than or equal to a preset threshold (e.g., a preset supply-demand ratio). The prompting information may remind the user information associated with the car-hailing service. For example, the prompting information may include traffic conditions (e.g., supply-demand ratios of one or more transportation services, traffic accidents, etc.), weather conditions, or the like, or a combination thereof. In some embodiments, the prompting information may be displayed in one or more user interfaces of the car-hailing application in a form of a prompting control element.

In some embodiments, the prompting information may be associated with a second transportation service. The second transportation service may include, for example, a carpooling service, a taxi-hailing service, a chauffeur service, a delivery service, a bus service, etc. In some embodiments, the supply-demand ratio of the second transportation service is greater than the supply-demand ratio of the first transportation service. In some embodiments, the second transportation service may differ from the first transportation service.

Merely by ways of example, the prompting information includes response information of the second transportation service. In some embodiments, the response information of the second transportation service may further include a response time of the second transportation service, and a name of the second transportation service.

The server 102 may determine whether vehicles providing the first transportation service are in short supply using the preset supply-demand ratio. In some embodiments, the server 102 may compare the supply-demand ratio of the first transportation service with the preset supply-demand ratio.

If the supply-demand ratio of the first transportation service is smaller than or equal to the preset supply-demand ratio, it is determined that the vehicles providing the first transportation service in the preset range of the terminal device are in short supply. In this case, the server 102 may send feed stream including at least one operating control element in the interface and prompting information include the response information of the second transportation service to the terminal device. The response information of the second transportation service may include a response time of the second transportation service. The response time of the second transportation service may refer to a time duration for at least one vehicle providing the second transportation service to respond to the service request of the user (e.g., a time duration for a vehicle providing the second transportation service to arrive the current location of the user). Merely for illustration purposes, the first transportation service may be a carpooling service which is in short supply, and the second transportation service may be a mini-bus service provided by mini-buses available for the user.

Thus, the user may obtain response information of a transportation service having a larger supply-demand ratio through the prompting information displayed in the service requesting interface when the vehicles providing the first transportation service are in short supply, such that the user may choose a transportation service from the first transportation service and the second transportation service based on the information, thereby improving the travel efficiency and overall experience of the user and reducing the customer attrition rate.

In some embodiments, the second transportation service may be a certain type of transportation service that the user accepts. Exemplary types of transportation services that the user accepts may include, for example, an economic type of transportation service (e.g., a carpooling service, a mini-bus service), a standardized type of transportation service (e.g., a taxi service, an express service, etc.), a luxurious type of transportation service (e.g., a premier service, a luxe service, etc.), or the like.

In some embodiments, the server 102 may determine the type of transportation service that the user accepts based on behavior data of the user. In some embodiments, the behavior data of the user may be obtained from the terminal device of the user. The behavior data of the user may include, for example, the selection of transportation services, the rating of transportation services of different types, historical travel time periods, interactions (e.g., clicks) with one or more operating control elements in the user interface of the car-hailing application. Merely by way of example, the server 102 may obtain historical car-hailing orders of the user, and determine the type of transportation service that the user accepts based on the historical car-hailing orders of the user. In some embodiments, the server may determine the type of transportation service that the user accepts based on the first transportation service. For example, if the first transportation service is a transportation service of an economical type, the server 102 may determine the second transportation service by selecting a transportation service with a higher supply-demand ratio from the transportation services of the economical type.

In some embodiments, the server 102 may designate a transportation service that is the type of transportation service that the user accepts and has a higher supply-demand ratio than that of the first transportation service in the preset range in which the terminal device is located as the second transportation service. Then the server 102 may generate the prompting information including response information of the second transportation service. In some embodiments, the server may designate a transportation service with a highest supply-demand ratio as the second transportation service.

Thus, the server may transmit feed stream including prompting information (e.g., in a form of a prompting control element) associated with the second transportation service based on the type of transportation service that the user accepts when vehicles providing the transportation service that the user selects are in short supply, such that effective information may be provided to the user, which may improve travel efficiency of the user, enhance success rate of car-hailing services, and reduce the customer attrition rate.

Merely by ways of example, when the user opens a service requesting interface of the car-hailing application to call a taxi via a service request, the terminal device 101 may send a request for feed stream of the service requesting interface to the server 102 over a network. If the server 102 determines that vehicles providing the taxis service in a preset range in which the terminal device is located are in short supply, the server 102 may determine the type of transportation service that the user accepts based on behavior data (e.g., historical orders of the user). If the type of transportation service that the user accepts is the economical type, and transportation services of the economical type include express service and bus service. The server 102 may determine supply-demand ratios of the express service and the bus service in the preset range in which the user is located, and designate a transportation service having a largest supply-demand ratio as the second transportation service.

For example, the transportation service having the largest supply-demand ratio may be the express service. The server 102 may transmit feed stream including at least one operating control elements necessary for the service requesting interface and prompting information (e.g., in the form of a prompting control element) including response information of the express service to the terminal device. Then the terminal device may display the prompting information in the service requesting interface, and the user of may be informed of the response information of the second transportation service, thereby improving travel efficiency and overall experience of the user.

Those of ordinary skill in the art may understand that all of the operations or a portion of the operations implementing the above embodiments may be accomplished by hardware instructed by program or computer codes. The programs or computer codes may be stored in a computer readable storage medium, and the operations including the above embodiments may be performed when the programs are executed. The storage medium may include media that may store program codes such as a ROM, a RAM, a magneto-optical disk, and an optical disk.

It should be noted that the above description is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for transmitting feed stream, comprising:
at least one storage medium storing a set of instructions;
at least one communication platform connected to a network; and
at least one processor configured to communicate with the at least one storage medium or the at least one communication platform, wherein when executing the set of instructions, the at least one processor is directed to cause the system to:
receive, over the network, a request for transmitting feed stream to a user interface of an application installed in a terminal device, wherein the request is associated with one or more users of the terminal device and the user interface is to be displayed to the one or more users;
determine at least one operating control element to be displayed in the user interface, wherein the operating control element is selected from one or more pre-arranged control elements based on historical behavior data of the one or more users; and
transmit feed stream to the terminal device over the network, wherein the feed stream is configured to prompt the application to display the operating control element in the user interface of the application.

2. The system of claim 1, wherein to determine the at least one operating control element to be displayed in the user interface, the at least one processor is directed to cause the system to:
process the historical behavior data to predict preferences of the one or more users and selecting the at least one operating control element according to the predicted user preferences.

3. The system of claim 1, wherein to determine the at least one operating control element to be displayed in the user interface, the at least one processor is directed to cause the system to:
determine a frequency that the one or more users view advertisements in the user interface based on the historical behavior data;
determine whether the frequency is smaller than a preset frequency; and
in response to the determination that the frequency is smaller than the preset frequency, select the at least one operating control element by excluding a control element corresponding to the advertisements.

4. The system of claim 1, wherein the one or more users include a service provider or a service requestor.

5. The system of claim 4, wherein the at least one operating control element associates the service requestor with the communication platform and the service provider.

6. The system of claim 4, wherein to determine the at least one operating control element to be displayed in the user interface, the at least one processor is directed to cause the system to:
determine the number of at least one first rate of a service provider based on the historical behavior data of the one or more users, wherein the first rate is larger than or equal to a preset rate;
determine whether the number of the at least one first rate is larger than or equal to a preset number; and
in response to the determination that the number of the at least one first rate is larger than or equal to the preset number, select the at least one operating control element by excluding a control element corresponding to the rating of the service provider.

7. The system of claim 1, wherein to determining the at least one operating control element to be displayed in the user interface, the at least one processor is directed to cause the system to:
determine whether the user terminal is a preset type of user terminal; and
in response to the determination that the user terminal is the preset type of user terminal, determine the one or more manipulation controls to be displayed in the user interface based on the preset type.

8. The system of claim 1, wherein the at least one processor is further directed to cause the system to:
obtain a location of the terminal device;
determine a supply-demand ratio of a first transportation service associated with the user interface within a preset range of the location of the terminal device;
determine whether the supply-demand ratio of the first transportation service is smaller than or equal to a preset supply-demand ratio; and
in response to the supply-demand ratio of the first transportation service is smaller than or equal to a preset supply-demand ratio, determine prompting information to be displayed in the user interface, wherein the prompting information includes a second transportation service, a supply-demand ratio of the second transportation service within the preset range of the location of the terminal device, and a response time of the second transportation service.

9. The system of claim 8, wherein the first transportation service and the second transportation service are car-hailing services.

10. (canceled)

11. The system of claim 8, wherein to determine the prompting information to be displayed in the user interface, the at least one processor is directed to cause the system to:
determine a type of the first transportation service;
determine a second transportation service based on the type of the first transportation service and the supply-demand ratio of the first transportation service, wherein the supply-demand ratio of the second transportation service is larger than the supply-demand ratio of the first transportation service;
obtain information of the second transportation service, wherein the information of the second transportation service includes the response time of the second transportation service; and
determine the prompting information to be displayed in the user interface based on the information of the second transportation service.

12. A method implemented on a computing device having at least one processor, at least one communication platform, and at least one computer-readable storage medium, the method comprising:
receiving, over a network, a request for transmitting feed stream to a user interface of an application installed in a terminal device, wherein the request is associated with one or more users of the terminal device and the user interface is to be displayed to the one or more users;
determining at least one operating control element to be displayed in the user interface, wherein the operating control element is selected from one or more pre-arranged control elements based on historical behavior data of the one or more users; and
transmitting feed stream to the terminal device over the network, wherein the feed stream is configured to prompt the application to display the operating control element in the user interface of the application.

13. The method of claim 12, wherein determining the at least one operating control element to be displayed in the user interface includes processing the historical behavior data to predict preferences of the one or more users and selecting the at least one operating control element according to the predicted user preferences.

14. The method of claim 12, wherein determining the at least one operating control element to be displayed in the user interface includes:
determining a frequency that the one or more users view advertisements in the user interface based on the historical behavior data;
determining whether the frequency is smaller than a preset frequency; and
in response to the determination that the frequency is smaller than the preset frequency, selecting the at least one operating control element by excluding a control element corresponding to the advertisements.

15. The method of claim 12, wherein the one or more users include a service provider or a service requestor.

16. The method of claim 15, wherein the at least one operating control element associates the service requestor with the communication platform and the service provider.

17. The method of claim 15, wherein determining the at least one operating control element to be displayed in the user interface includes:
determining the number of at least one first rate of a service provider based on the historical behavior data of the one or more users, wherein the first rate is larger than or equal to a preset rate;
determining whether the number of the at least one first rate is larger than or equal to a preset number; and
in response to the determination that the number of the at least one first rate is larger than or equal to the preset number, selecting the at least one operating control element by excluding a control element corresponding to the rating of the service provider.

18. The method of claim 12, wherein determining the at least one operating control element to be displayed in the user interface includes:
determining whether the user terminal is a preset type of user terminal; and
in response to the determination that the user terminal is the preset type of user terminal, determining the one or more manipulation controls to be displayed in the user interface based on the preset type.

19. The method of claim 12, further comprising:
obtaining a location of the terminal device;
determining a supply-demand ratio of a first transportation service associated with the user interface within a preset range of the location of the terminal device;
determining whether the supply-demand ratio of the first transportation service is smaller than or equal to a preset supply-demand ratio; and
in response to the supply-demand ratio of the first transportation service is smaller than or equal to a preset supply-demand ratio, determining prompting information to be displayed in the user interface, wherein the prompting information includes a second transportation service, a supply-demand ratio of the second transportation service within the preset range of the location of the terminal device, and a response time of the second transportation service.

20. (canceled)

21. The method of claim 19, wherein determining the prompting information to be displayed in the user interface includes:
determining a type of the first transportation service;
determining a second transportation service based on the type of the first transportation service and the supply-demand ratio of the first transportation service, wherein the supply-demand ratio of the second transportation service is larger than the supply-demand ratio of the first transportation service;
obtaining information of the second transportation service, wherein the information of the second transportation service includes the response time of the second transportation service; and
determining the prompting information to be displayed in the user interface based on the information of the second transportation service.

22. A non-transitory computer readable medium, comprising a set of instructions, wherein when executed by at least one processor, the set of instructions directs the at least one processor to effectuate a method, the method comprising:
receiving, over a network, a request for transmitting feed stream to a user interface of an application installed in a terminal device, wherein the request is associated with one or more users of the terminal device and the user interface is to be displayed to the one or more users;
determining at least one operating control element to be displayed in the user interface, wherein the operating control element is selected from one or more pre-arranged control elements based on historical behavior data of the one or more users; and
transmitting feed stream to the terminal device over the network, wherein the feed stream is configured to prompt the application to display the operating control element in the user interface of the application.
